(19) United States
(12) Patent Application Publication
(10) Pub. No.: US 2004/0231874 A1
(43) Pub. Date: Nov. 25, 2004

(54) Spillover fitting for cable routing systems

(76) Inventors: Jack E. Caveney, Hinsdale, IL (US); Robert Nicoli, Glenwood, IL (US); Charles VanderVelde, Frankfort, IL (US); Dale A. Block, Schererville, IN (US)

Correspondence Address: PANDUIT CORP., LEGAL DEPARTMENT - TP12, 17301 SOUTH RIDGELAND AVENUE, TINLEY PARK, IL, 60477, US

(21) Appl. No.: 10/819,662

(22) Filed: Apr. 7, 2004

Related U.S. Application Data
(60) Provisional application No. 60/461,688, filed on Apr. 9, 2003.
(60) Provisional application No. 60/474,136, filed on May 29, 2003.

(51) Int. Cl. H02G 3/04

(52) U.S. Cl. 174/48

(57) ABSTRACT

The embodiments provide a spillover fitting that allows cable to be routed out of a cable routing channel in a manner that allows for the transition of routing of the cable from a generally horizontal direction to a generally vertical direction. The spillover fitting includes a transition guide that receives cable from a raceway channel and routes the cable out of the channel and into a downward guide, avoiding subjecting the cable to an abrupt transition by orienting the transition guide at an angle less than 90° to the raceway channel. The spillover fitting includes an attachment member for securing the fitting to an outer surface of the bottom wall of the raceway channel and may include a hinged cover over the downward guide.

### RELATED APPLICATIONS

This application claims the benefit of U.S. Provisional Application 60/461,688, filed Apr. 9, 2003, and U.S. Provisional Application 60/474,136, filed May 29, 2003, the entirety of both previously filed applications being incorporated herein by reference.

### BACKGROUND

1. Field of the Invention

The present invention relates to the field of cable routing systems. More specifically, the invention relates to a spillover fitting that allows cable to be routed out of a cable routing channel in a manner that allows for transition of the cable from a generally horizontal direction to a generally vertical direction.

2. Background

Cable routing systems have become very popular in recent years to route, protect, and conceal data, voice, video, fiber optic, and/or power cabling. Such systems allow custom installation and can be provided within walls or provided on external surfaces, allowing ready access for reconfiguration, repair, or installation of additional equipment. Such systems may typically include various sections of raceway channel, including straight sections and various fittings, such as 90° elbow fittings, 45° elbow fittings, T-fittings, four-way intersection (x) fittings, and the like, respective ones of which are affixed together by duct couplers to cumulatively form a raceway system.

Such raceway systems are used to route cable, such as optical fiber, for example, both throughout a building and within an equipment room in a building. Cable is often carried in an overhead raceway system suspended from the ceiling, thereby requiring a means of routing cable downwardly from the overhead raceway to a given piece of equipment located on the floor. In transitioning cable downwardly from a horizontal direction to a vertical direction, it is important protect the integrity of the cable, especially fiber optic cable, such as from bending too sharply, thereby damaging the cable. Accordingly, such transitions should include bend-radius control features to control the degree of bending allowed.

Additionally, because equipment may be added or moved after the raceway has been assembled and installed, it may become necessary to add new downward transitions at various points along the raceway channel. Therefore, a certain degree of flexibility is desirable in allowing for installation of the downward transition at any point along the horizontal run of the raceway. Prior art fittings intended to introduce a downward transition have required the removal of a section of channel to accommodate inserting a vertical tee fitting, or have required that the side wall of the channel be at least partially removed, with the cable routed out through the opening in the side wall of the horizontal duct, or have caused cable to be routed over a trough affixed to the top edge of the horizontal duct side wall, such as depicted in U.S. Pat. No. 6,192,181 (assigned to ADC Telecommunications, Inc.). However, most such prior art transitions are designed such that the cable is routed into a direction transverse to the direction of travel in the raceway duct, that is, the transition includes an exit trough oriented essentially perpendicularly to the raceway duct. Despite the inclusion of bend radius control features, such transitions cause the cable to change direction in a very short distance. In contrast, the present invention includes a transition guide section set at an angle less than 90° to the horizontal raceway duct, providing for a more gradual transition from the horizontal direction to the vertical direction, thereby avoiding subjecting the cable to an abrupt transition.

### SUMMARY

In one embodiment, there is provided a spillover fitting for routing cable out of a cable raceway channel, the spillover fitting comprising a transition guide that receives cable from a raceway channel and directs the cable over a sidewall of the raceway channel, the transition guide oriented at an angle less than 90° to the raceway channel when mounted thereto, and a downward guide that receives cable from the transition guide and directs it downwardly with respect to the raceway channel.

In another embodiment, there is also provided a spillover fitting in which the transition guide includes a cable entry end and a cable exit end, the cable entry end and the cable exit end having at least a 2″ minimum bend radius.

In another embodiment, the spillover fitting comprises an attachment member for securing the spillover fitting to an outer surface of a bottom wall of the raceway channel, the attachment member comprising at least one rail that mates with at least one slot on the outer surface of the bottom wall of the raceway channel, the fitting secured to the raceway channel by at least one fastener that secures the at least one rail of the attachment member to the at least one slot of the raceway channel.

In another embodiment there is also provided a cable raceway system comprising a raceway channel that conducts cable in a horizontal direction, the raceway channel having at least one side wall and a bottom wall, a spillover fitting that mounts to the raceway channel, wherein the spillover fitting comprises a transition guide that receives cable from a raceway channel and directs the cable over a sidewall of the raceway channel, the transition guide oriented at an angle less than 90° to the raceway channel, and a downward guide that receives cable from the transition guide and directs it downwardly with respect to the raceway channel. The cable routing system may optionally include a T-section coupled to the downward section, to allow cable to bypass the downward section, continuing in a horizontal direction to another downward section of vertical tee fitting.

### BRIEF DESCRIPTION OF THE DRAWINGS

Embodiments of the present invention are described herein with reference to the drawings, in which:

FIG. 1 is a perspective view of an embodiment of the spillover fitting, equipped with a hinged cover located over the spillover fitting and the raceway channel, the spillover fitting shown mounted to a raceway channel.

FIG. 2 is a top view of an embodiment of the spillover fitting shown mounted to a raceway channel.

FIG. 3 is a front view of an embodiment of the spillover fitting shown mounted to a raceway channel.

FIG. 4 is a side view of an embodiment of the spillover fitting, equipped with a hinged cover located over the spillover fitting and the raceway channel, the spillover fitting shown mounted to a raceway channel.

FIG. 5A depicts an embodiment of the attachment member of the spillover fitting.

FIG. 5B depicts a second embodiment of the attachment member of the spillover fitting.

FIG. 6 is a perspective view of an embodiment of the spillover fitting shown not mounted to a raceway channel.

FIG. 7 is a perspective view of an embodiment of the spillover fitting equipped with a hinged cover over the downward guide section.

FIG. 8 is a top view of an embodiment of the spillover fitting shown not mounted to a raceway channel.

FIG. 9 is a top view of an embodiment of the spillover fitting equipped with a hinged cover over the downward guide section, depicting the opening and closing of the hinged cover.

FIG. 10 is a top view of an embodiment of the spillover fitting equipped with a hinged cover over the downward guide section, depicting the opening and closing of the hinged cover.

FIG. 11 is a front view of an embodiment of the spillover fitting shown not mounted to a raceway channel.

FIG. 12 is a top view of an embodiment of the spillover fitting equipped with a hinged cover over the downward guide section, with the hinged cover removed to illustrate an embodiment of the cover hinge.

FIG. 13 is a perspective view of an embodiment of the spillover fitting shown not mounted to a raceway channel, depicting an embodiment of the attachment member of the spillover fitting.

FIG. 14 is a perspective view of an embodiment of the spillover fitting shown not mounted to a raceway channel, depicting a second embodiment of the attachment member of the spillover fitting.

FIG. 15 is a perspective view of the underside of an embodiment of the spillover fitting shown not mounted to a raceway channel, depicting a second embodiment of the attachment member of the spillover fitting.

FIG. 16 is a perspective view of an embodiment of the spillover fitting shown mounted to a raceway channel.

FIG. 17 is a perspective view of an embodiment of the spillover fitting shown mounted to a raceway channel.

FIG. 18 is a top view of an embodiment of the spillover fitting shown mounted to a raceway channel.

FIG. 19 is a front view of an embodiment of the spillover fitting shown mounted to a raceway channel.

FIG. 20 is a side view of an embodiment of the spillover fitting shown mounted to a raceway channel.

FIG. 21 is a perspective view of an embodiment of the spillover fitting shown mounted to a raceway channel.

FIG. 22 is a bottom view of an embodiment of the spillover fitting shown mounted to a raceway channel.

FIG. 23 is a perspective view of a second embodiment of the spillover fitting shown mounted to a raceway channel.

FIG. 24 is a front view of a second embodiment of the spillover fitting shown mounted to a raceway channel, the dashed line indicating the path of cable through the fitting.

FIG. 25 is a top view of a second embodiment of the spillover fitting shown mounted to a raceway channel, the dashed line indicating the path of cable through the fitting.

FIG. 26 is a side view of a second embodiment of the spillover fitting shown mounted to a raceway channel, the dashed line indicating the path of cable through the fitting.

### DETAILED DESCRIPTION

This application is directed to an improved spillover fitting for use in cable routing systems. U.S. Pat. No. 6,192,181 B1, discussed above, provides a description of the general background and environment for fittings and cable routing systems of this type, and the specification of that issued patent is incorporated herein by reference as though set forth here in full.

The spillover fitting of this application provides a new and improved structure and technique for cables to be routed into and out of a raceway channel by guiding the cables over the sidewall of the channel while protecting the fibers against damage. The fitting provides a transition method for directing cable into or out of existing installations where installing an additional vertical tee fitting would be difficult. Further, such a fitting can be installed without the need for cutting into the channel sidewall.

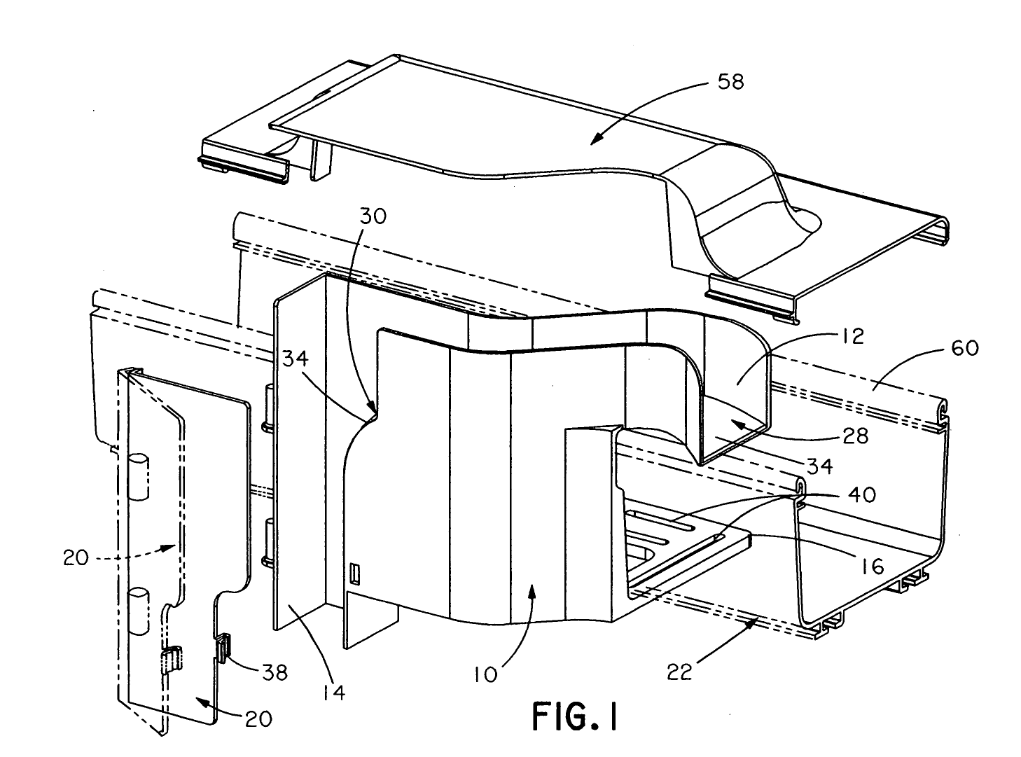

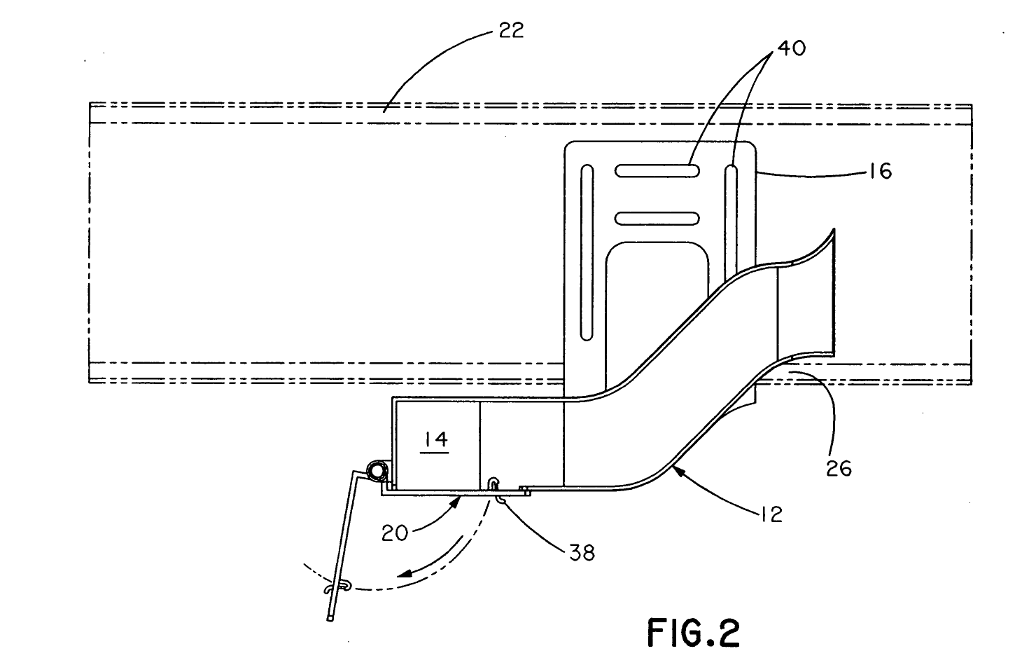

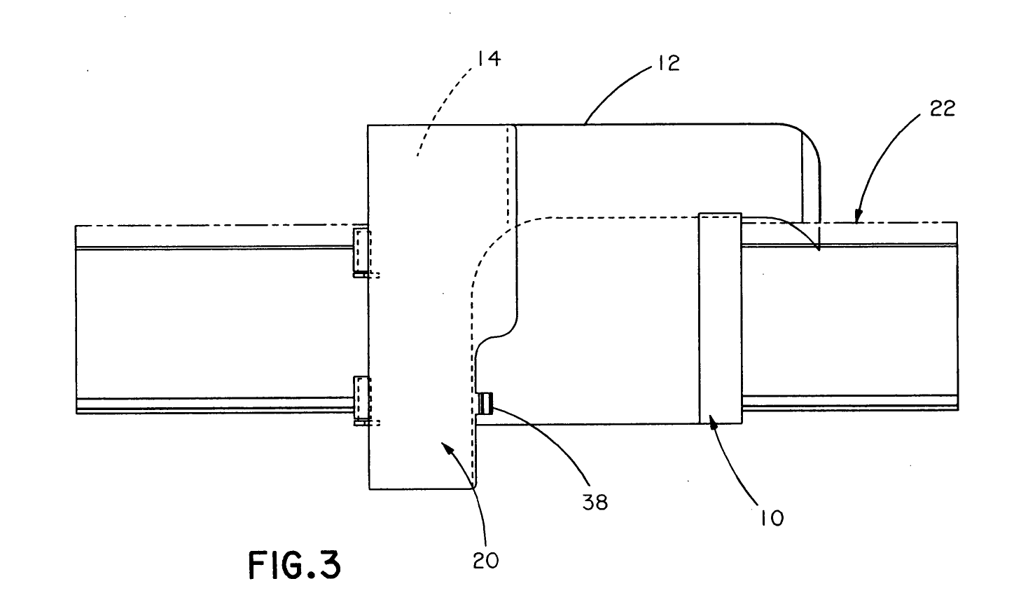

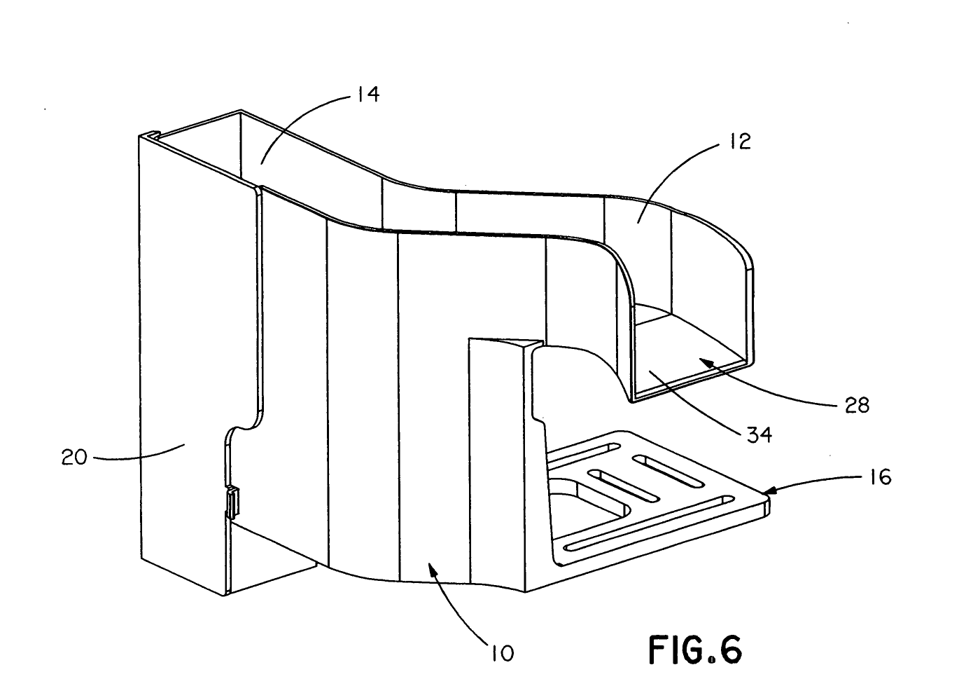

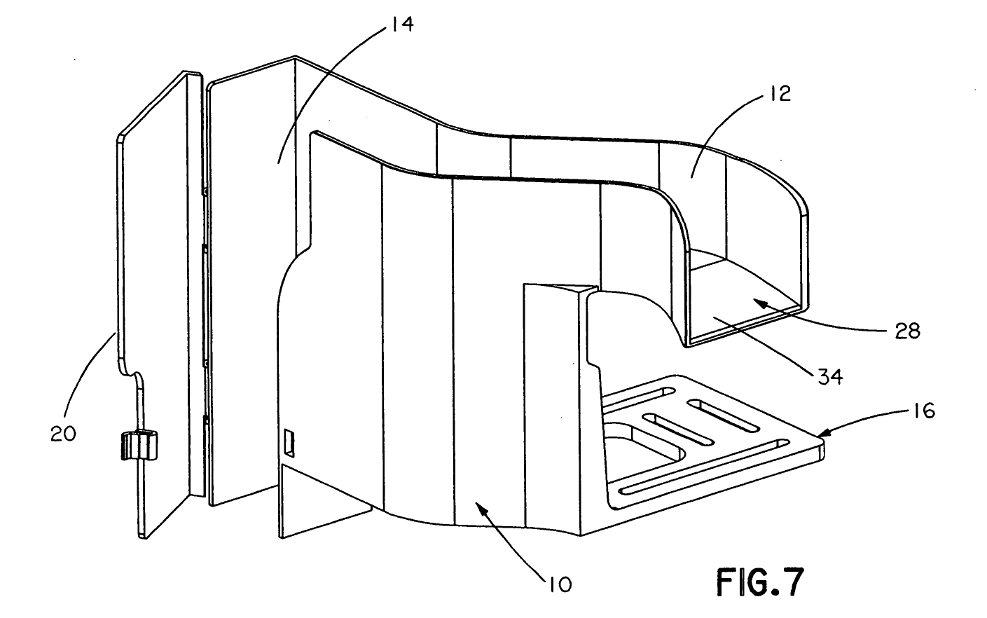

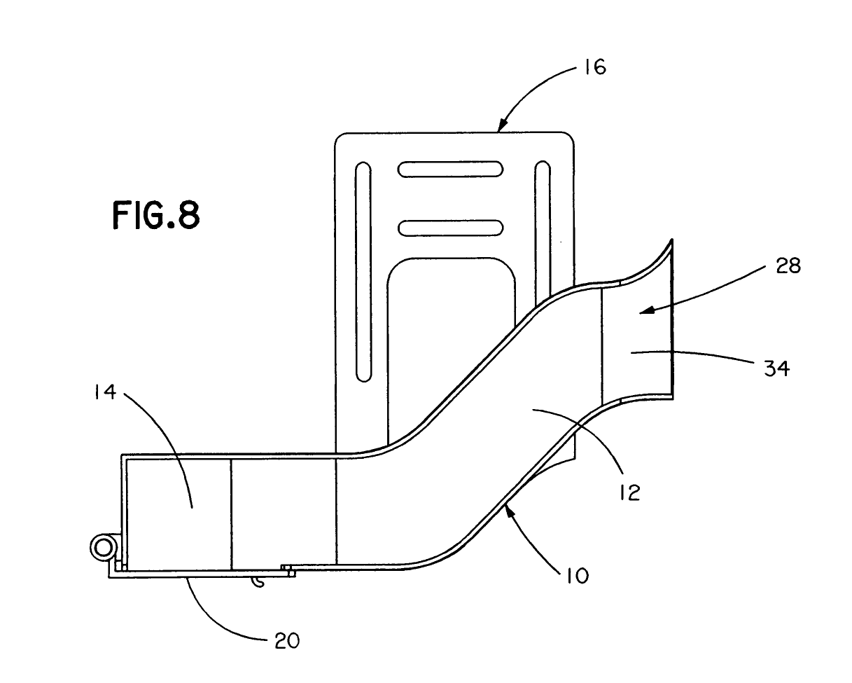

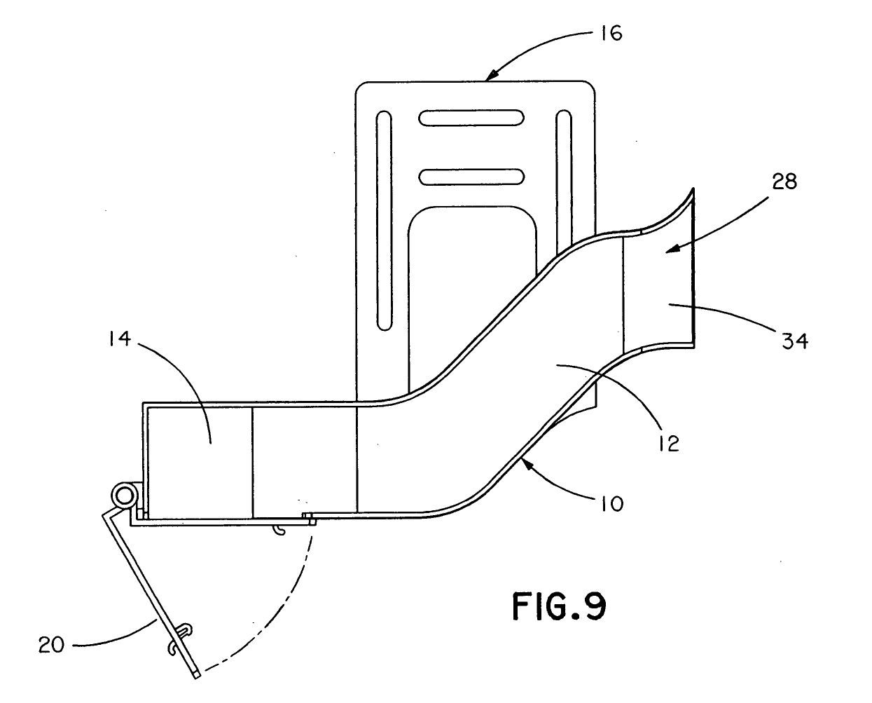

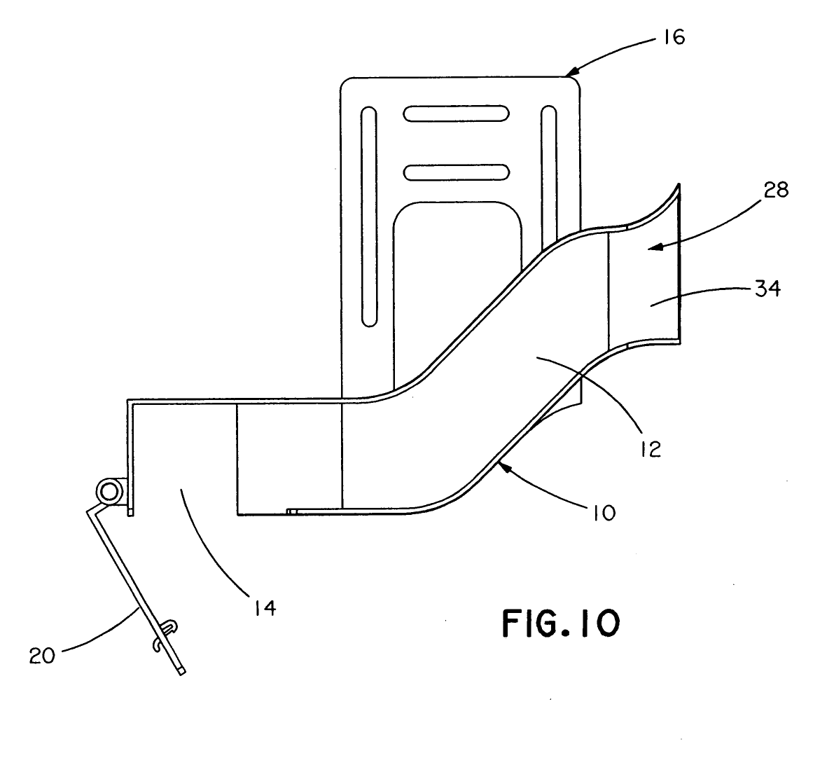

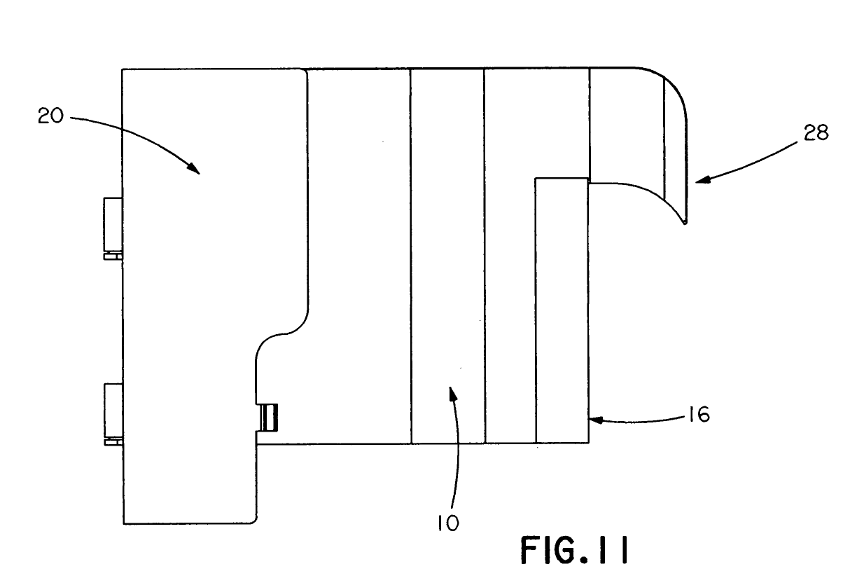

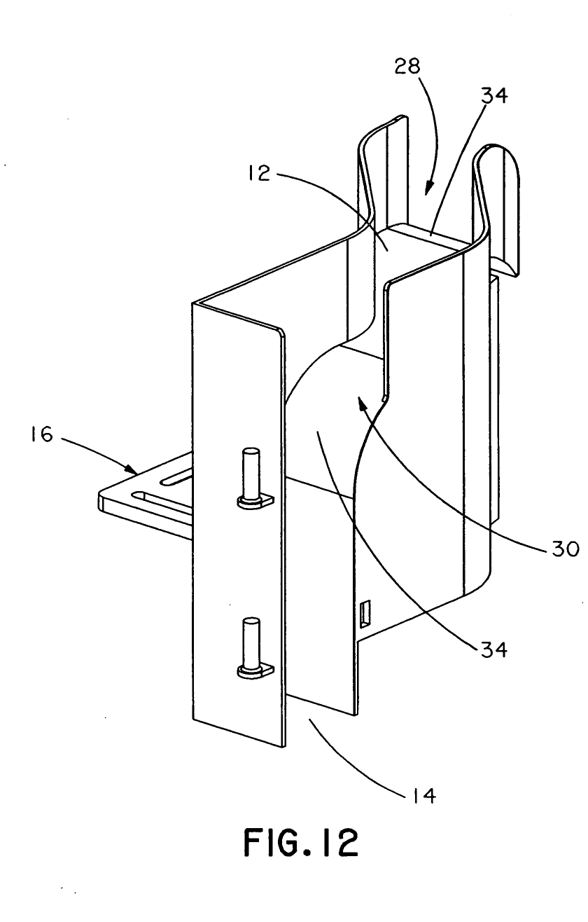

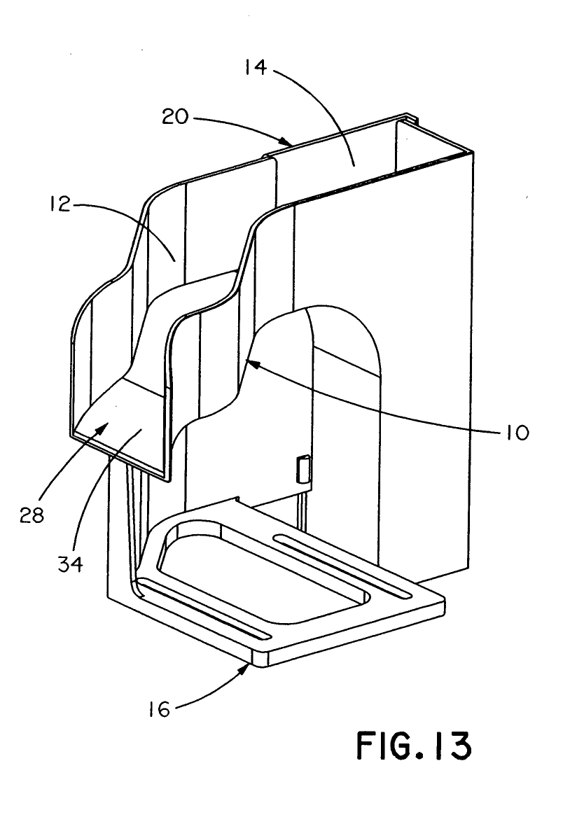

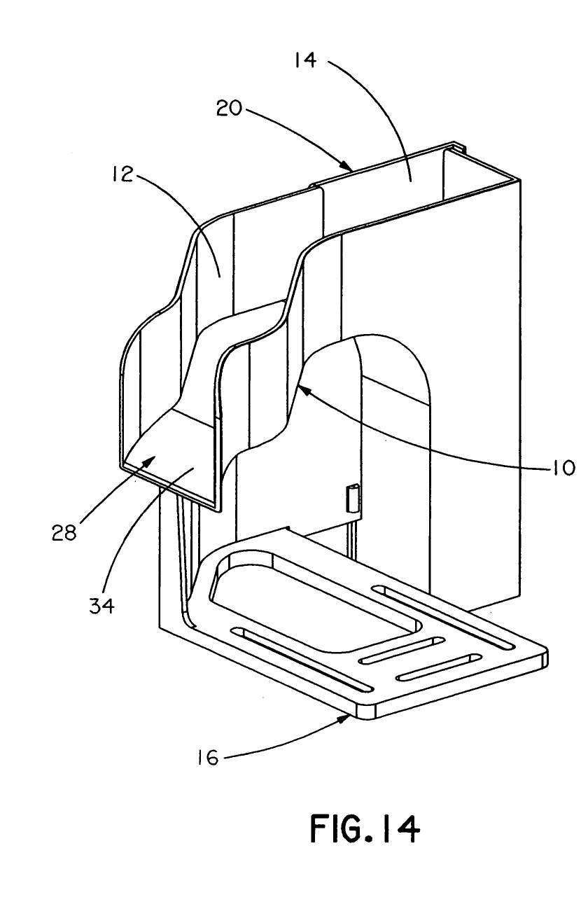

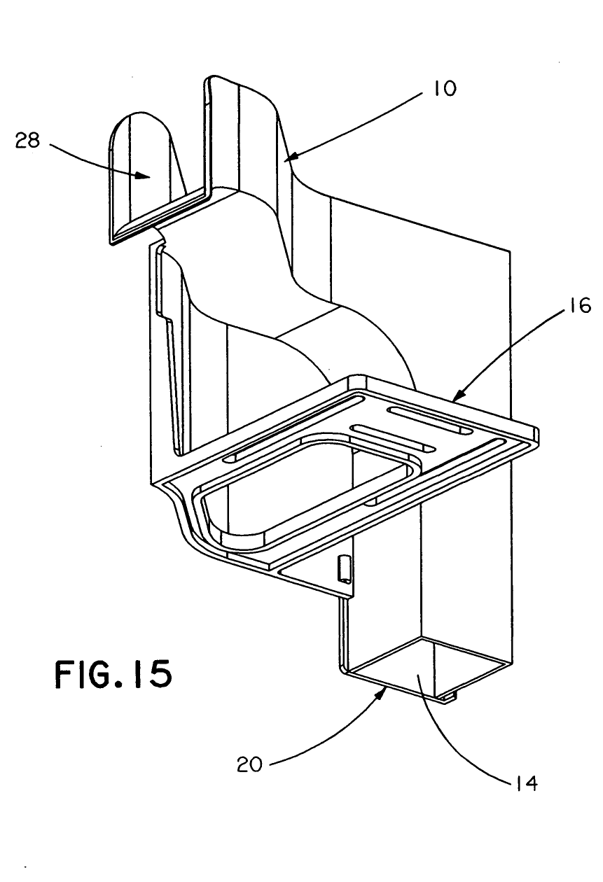

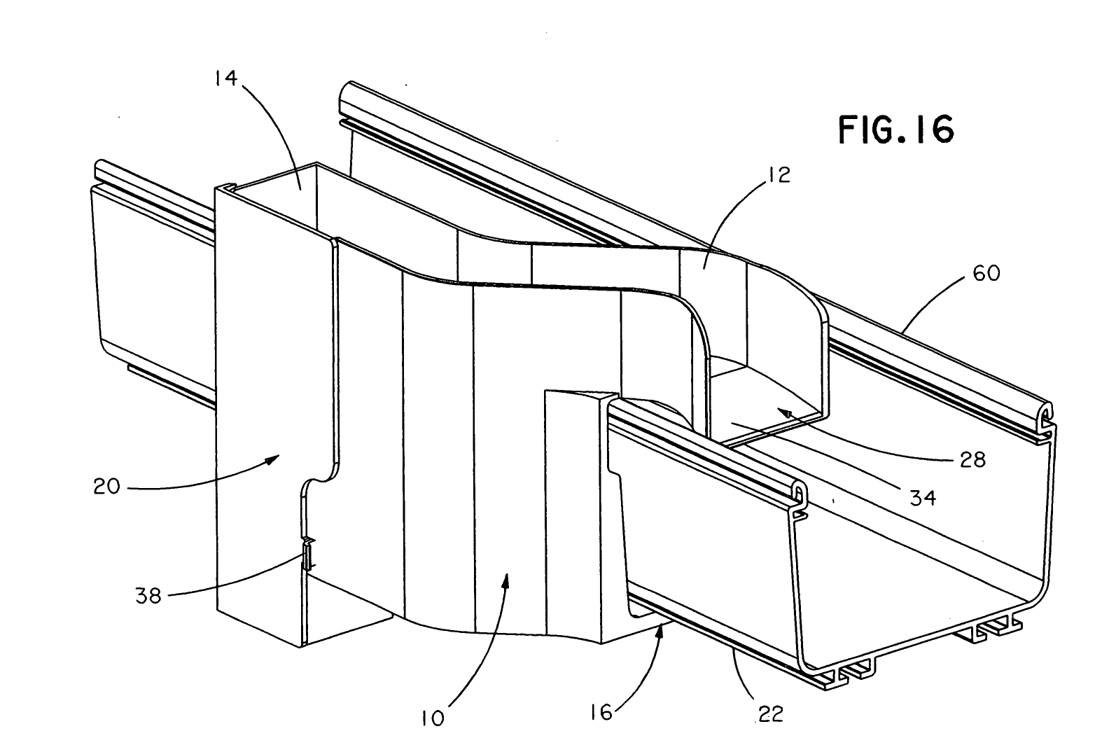

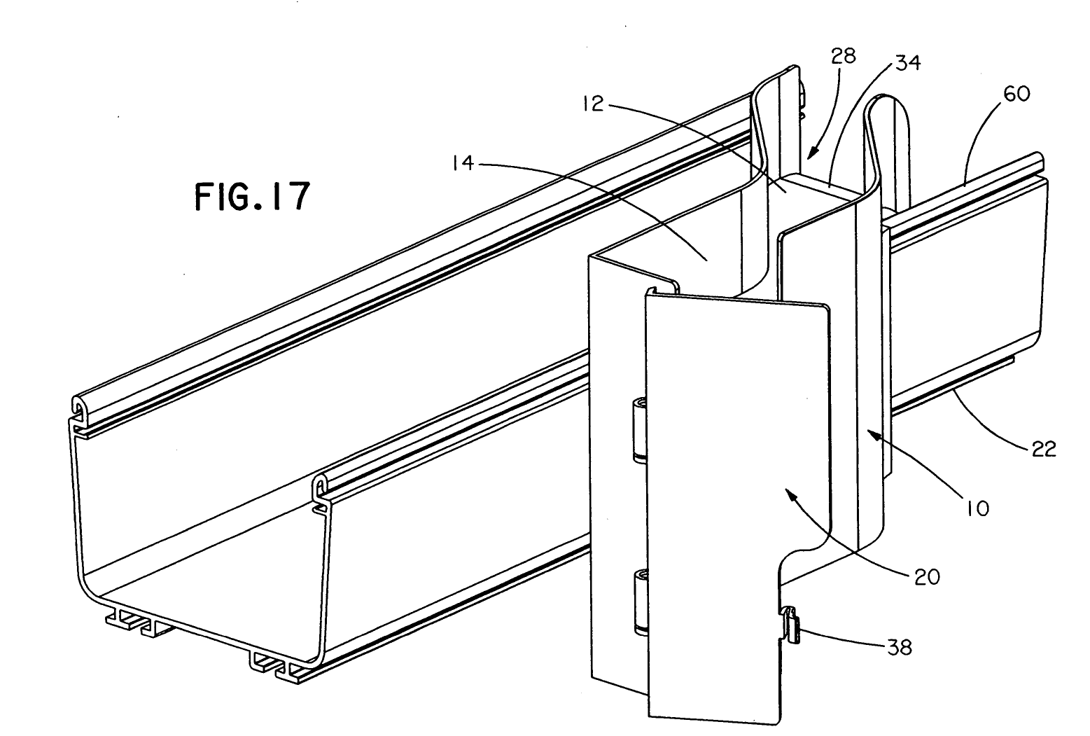

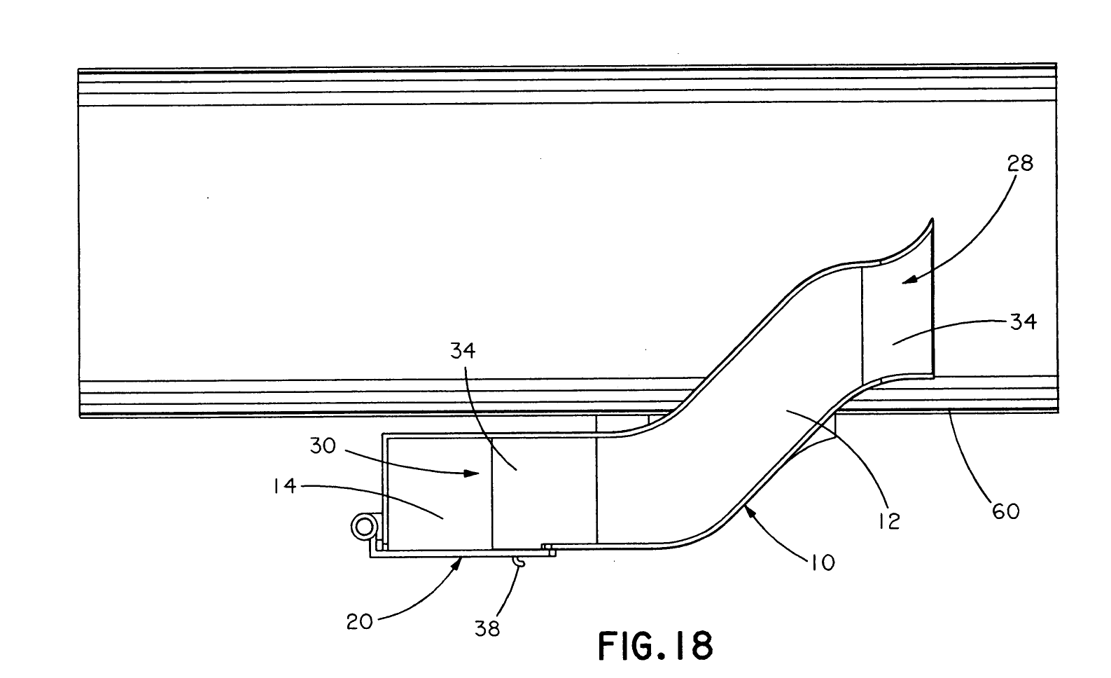

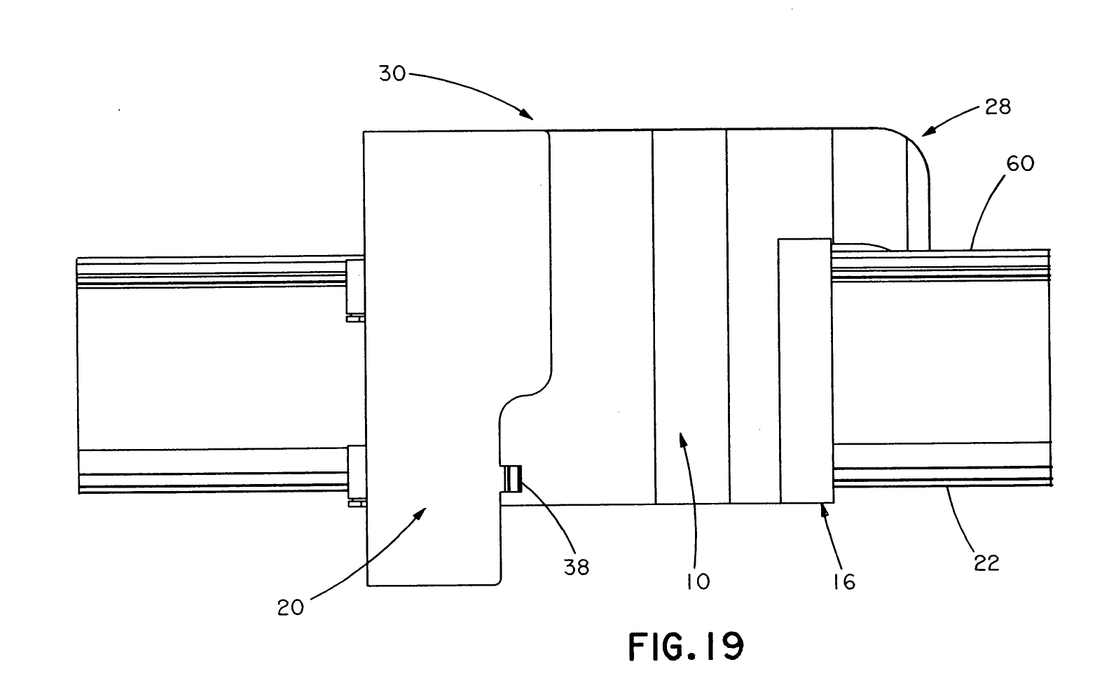

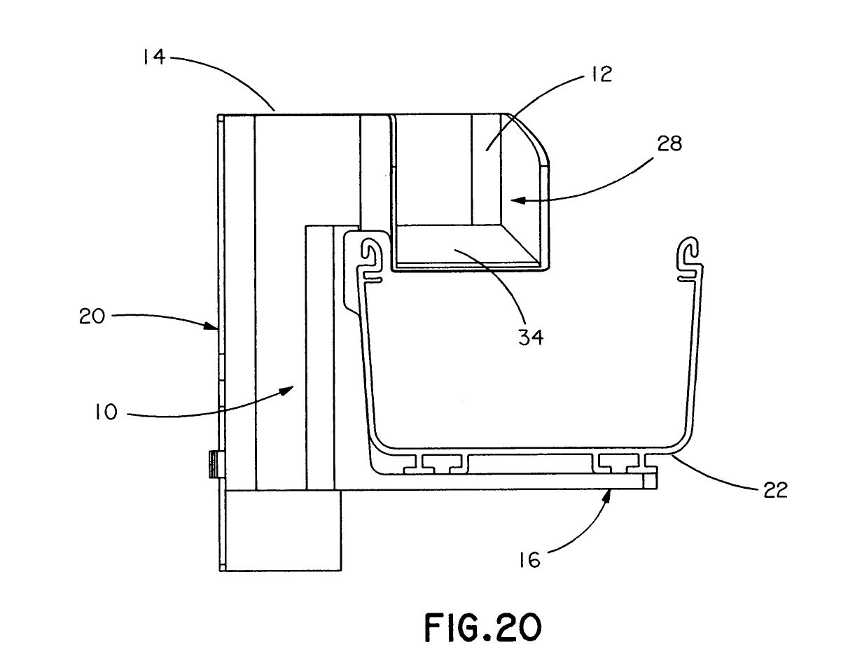

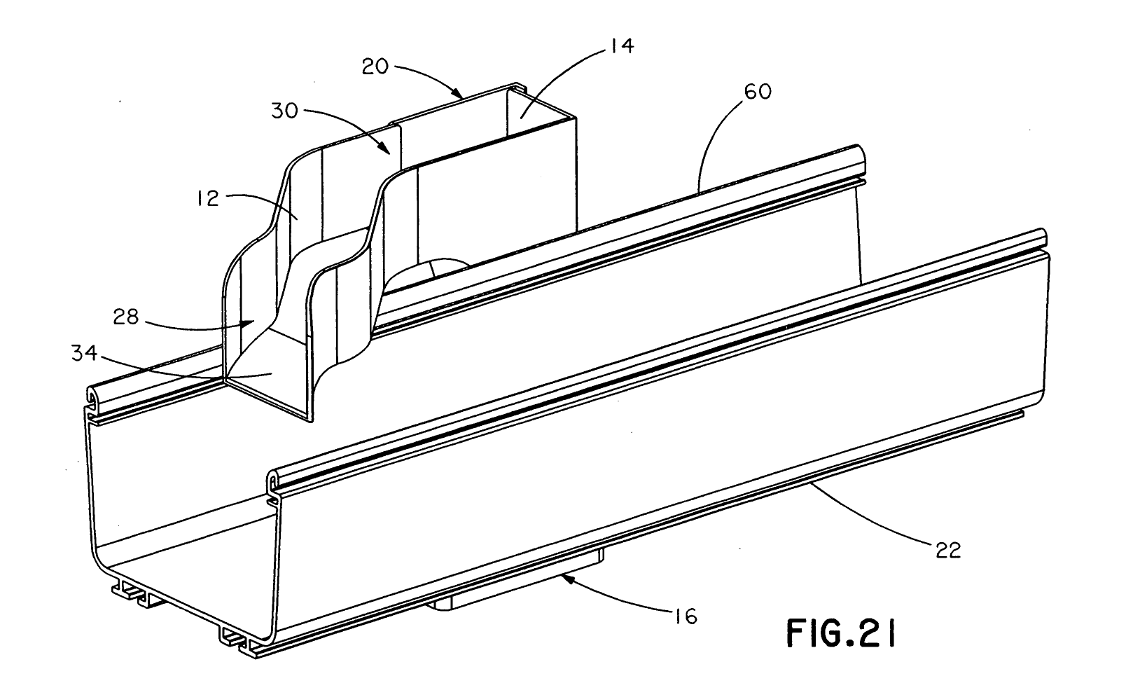

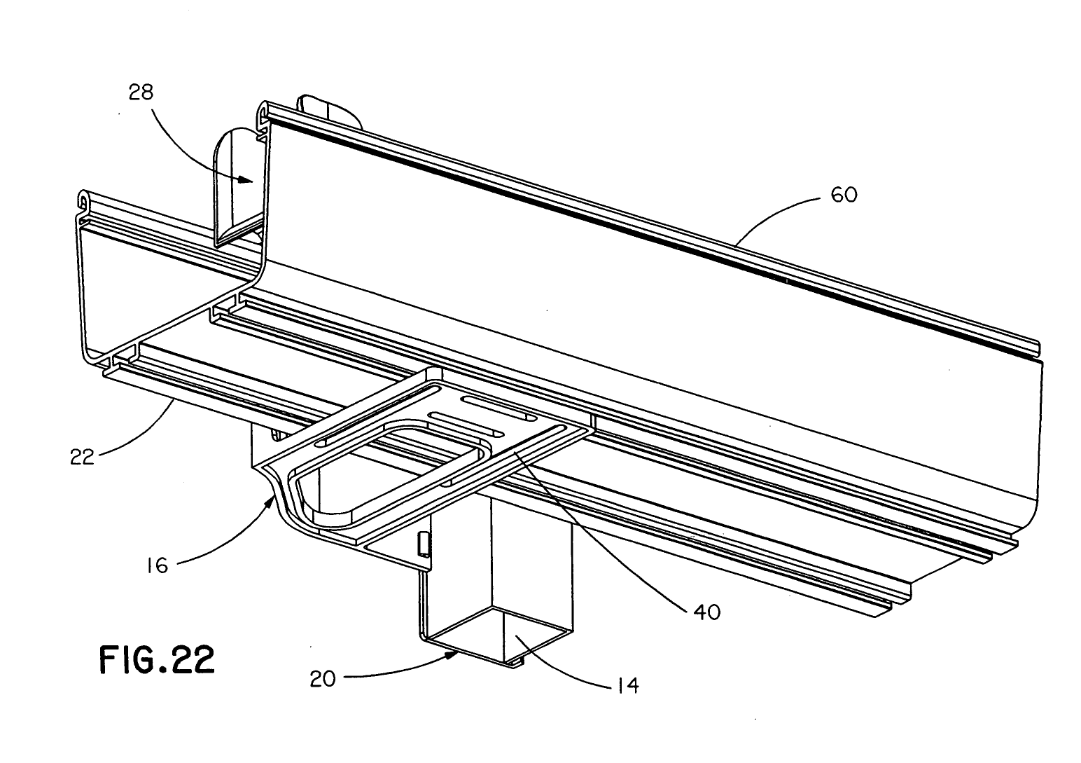

FIGS. 1-22 depict a first embodiment of the spillover fitting of this invention. Referring to FIG. 1, the fitting 10 comprises a curved transition guide section 12, a downward guide section 14, an attachment member 16, and a vertical cover 20 provided on the downward guide section. Transition guide section 12 includes a cable entry end 28 and a cable exit end 30. In the embodiment of the spillover fitting depicted in FIGS. 1 and 2, the portions of transition guide 12 immediately adjacent entry and exit ends 28, 30 are generally parallel to the raceway channel 22. An angled central portion 13 of transition guide 12 connects entry and exit ends 28,30. The transition guide 12 is mounted to the channel 22 in such a manner as to form an angle of less than 90° with respect to the channel 22. In the embodiment of the spillover fitting depicted in FIG. 2, this angle is roughly 45° although other arrangements forming other angles less than 90° are possible and encompassed by the scope of the invention.

As can be appreciated from FIGS. 1 and 2, the curved transition section 12 of the fitting guides the cables upwardly from the channel 22 and over the sidewall 26 of the channel 22 to the downward section 14. Both the entry and exit ends 28, 30 of the transition section 12 are provided with curved surfaces 34 to maintain an appropriate minimum bend radius, for example, a minimum 2″ bend radius, thereby protecting the cables from damage. Once in the downward section 14, the cables are guided in a vertical direction to the next destination such as, for example, an equipment rack (not shown).

The downward section 14 may optionally be provided with a cover 20 that acts to protect the cables and retain them within the downward guide 14. The embodiment of the spillover fitting 10 depicted in FIGS. 1-22 includes a hinged cover 20 located to cover the downward guide section 14. When the cables have been guided through the downward section 14, the vertical cover 20 can be pivoted from its open position, shown in dotted line, to its closed position, thereby further protecting the cables. The cover 20 is maintained in its desired position by the use of a latch 38.

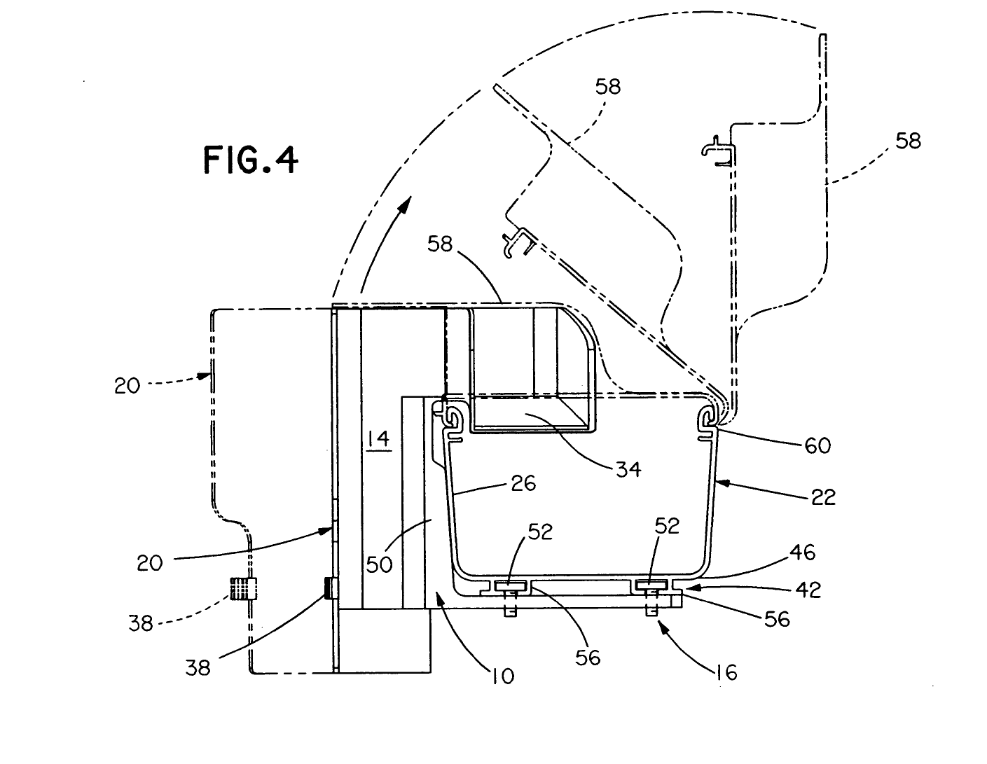

Referring to FIGS. 1 and 4, the attachment member 16 includes a plurality of rails 40 for mating with the slots 42 provided on the outer surface of the bottom wall 46 of the channel 22. To mount the fitting 10 to the channel 22, the attachment member 16 is placed underneath the bottom wall 46 of the channel 22 and the sidewall 50 of the fitting is abutted against the sidewall 26 of the channel 22, as seen in FIG. 4. Once the fitting 10 is placed in the mounting arrangement, fasteners 52 are used to attach the slots 42 of the channel 22 with the rails 40 of the attachment member 16. When the fasteners 52 are in place, the mounting legs 56 of the slots 42 along the bottom wall 46 of the channel 22 rest on top of the attachment member 16, as shown in FIG. 4.

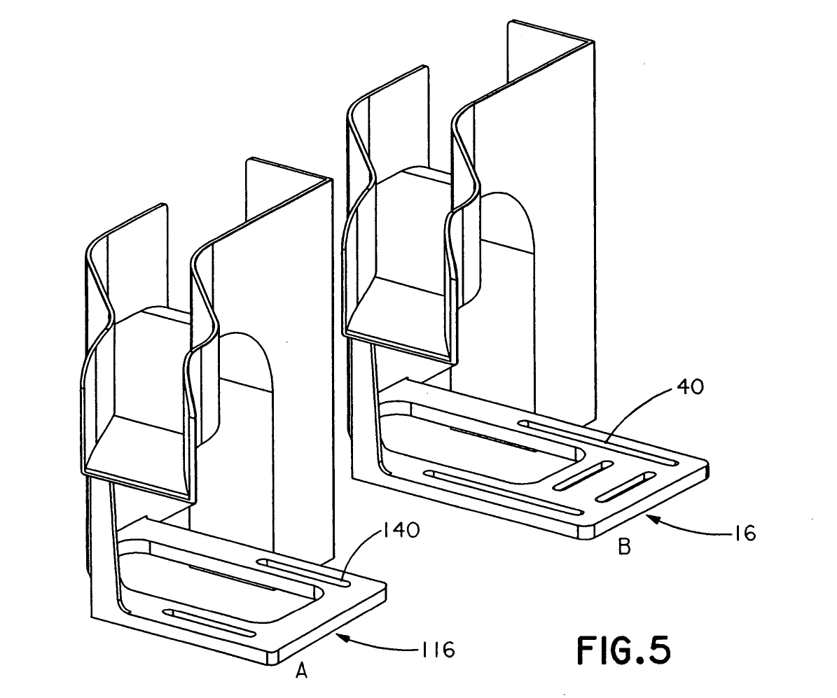

In FIG. 1, 2, and 5B, a first embodiment of the attachment member 16 is shown, while FIG. 5A depicts a second embodiment. In the first embodiment, the attachment member 16 is provided with one or more rails 40 to enable attachment of the fitting to both of the slots 42 on the bottom wall 46 of the channel 22. In the second embodiment, the attachment member 116 is provided with one or more rails 140 to enable attachment to a single row of slots on the bottom wall of the channel.

Once the fitting 10 has been mounted onto the channel 22, a top cover 58 may provided to cover both the fitting 10 and a portion of the channel 22. As can be seen in FIG. 4, the top cover 58 can be pivoted from its open position, shown in dotted line, to its closed position, thereby further protecting the cables. The cover 58 is mounted onto the channel 22 by a side rail 60. The pivot mechanism may comprise any hinge or pivot means known to those of skill in the art. In preferred form, the pivot mechanism comprises the hinge approach described in U.S. Pat. No. 6,437,244, which is incorporated herein by reference as though set forth here in full.

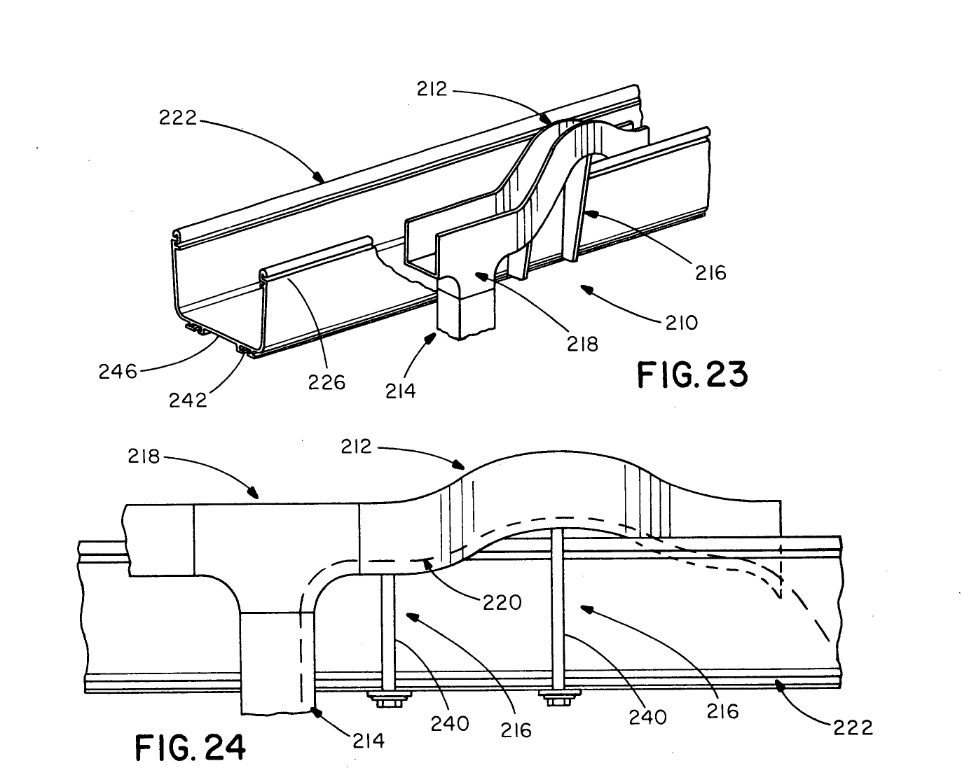

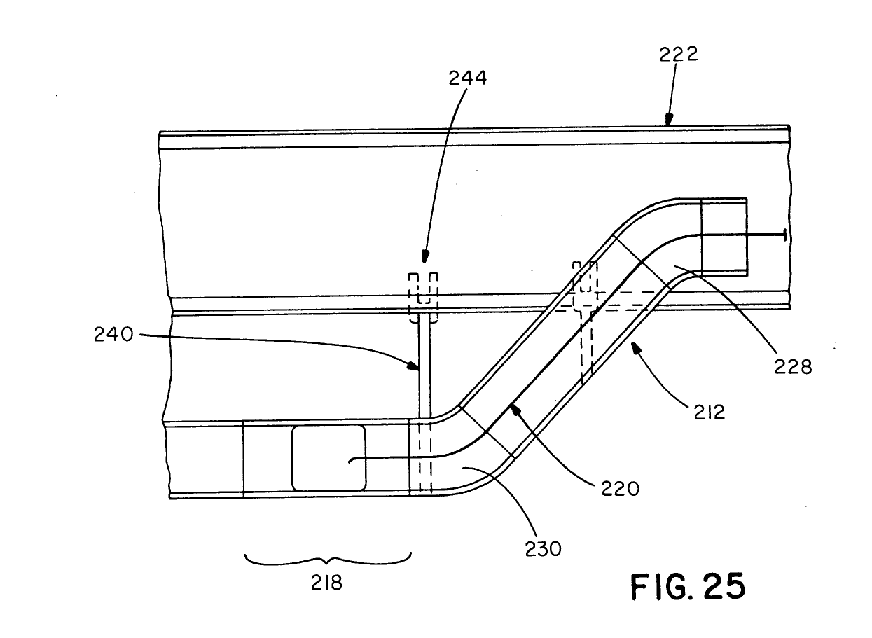

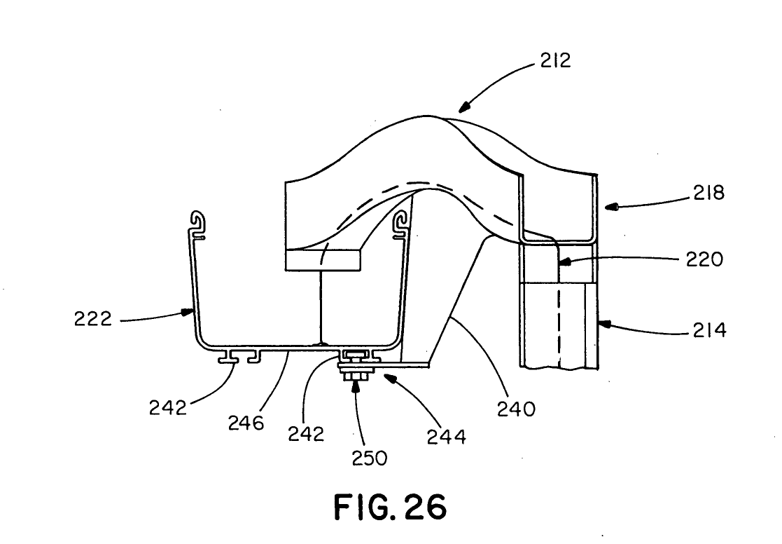

A second embodiment of the spillover fitting is depicted in FIGS. 23-26. In the embodiment of the spillover fitting shown in FIGS. 23-26, the fitting 210 comprises a curved transition guide section 212, a downward guide section 214, an attachment and support member 216, and a T-section 218. As depicted in FIGS. 23-26, the curved transition guide section 212 of the spillover fitting 210 guides the cables 220 upwardly and outwardly from the channel section 222 and over the sidewall 226 of the channel section 222 to the T-section 218 and the downward guide section 214. The transition guide section is oriented at an angle less than 90° with respect to the raceway channel 222. Both the entry and exit ends 228, 230 of the curved transition guide section 212 are provided with curved surfaces to maintain a minimum 2″ bend radius, thereby protecting the cables from damage. Once in the downward guide section 214, the cables are guided in a vertical direction to the next destination such as, for example, an equipment rack. A cover can be included over the transition section 212, the T-section 218, and/or the downward guide section 214, to further protect the cables.

The T-section 218 of the spillover fitting 210 allows cables to optionally bypass the downward guide section 214, thus permitting the cables to continue in a horizontal direction along a subsidiary channel section attached to the T-section (not shown) and transitioned downwards at additional T-sections and/or downward guide sections. The T-section 218 also allows for additional spillover fittings, connected to other parallel running channel sections, to be attached to the downward guide section 214.

The attachment and support member 216 includes a support section 240 which is attached at one end to the bottom side of the curved transition guide section 212 or the T-section 218. The support section 240 may be tapered, as shown in FIG. 1. The second end of the support section 240 comprises an attachment section, such as a forked mounting plate 244. The spillover fitting 210 is attached to the channel section 222 by connecting the forked mounting plate 244, with, for example a T-bolt, a washer, and a nut 250, to slot 242 provided on the outer surface of the bottom wall 246 of the channel section 222. Multiple attachment and support members 216 may be used for attaching the spillover fitting 210 to the channel section 222.

1. A spillover fitting for routing cable out of a cable raceway channel, the spillover fitting comprising:
a transition guide that receives cable from a raceway channel and directs the cable over a sidewall of the raceway channel, the transition guide oriented at an angle less than 90° to the raceway channel when mounted thereto;
a downward guide that receives cable from the transition guide and directs it downwardly with respect to the raceway channel.

2. The spillover fitting of claim 1, wherein the transition guide includes a cable entry end and a cable exit end, the cable entry end and the cable exit end having at least a 2″ minimum bend radius.

3. The spillover fitting of claim 1 further comprising an attachment member for securing the spillover fitting to an outer surface of a bottom wall of the raceway channel.

4. The spillover fitting of claim 3, wherein the attachment member comprises at least one rail that mates with at least one slot on the outer surface of the bottom wall of the raceway channel, the fitting secured to the raceway channel by at least one fastener that secures the at least one rail of the attachment member to the at least one slot of the raceway channel.

5. The spillover fitting of claim 1, further comprising a hinged cover located to cover the downward guide section.

6. A spillover fitting for routing cable out of a cable raceway channel, the spillover fitting comprising:
a transition guide that receives cable from a raceway channel and directs the cable over a sidewall of the raceway channel, the transition guide defining a cable channel having a bottom wall and upright side walls, and further comprising a cable entry end, an angled central portion and a cable exit end, wherein the transition guide is oriented at an angle less than 90° to the raceway channel when mounted thereto;
a downward guide that receives cable from the transition guide and directs it downwardly with respect to the raceway channel.

7. The spillover fitting of claim 6, wherein the cable entry end and cable exit end have at least a 2″ minimum bend radius.

8. The spillover fitting of claim 6 further comprising an attachment member for securing the spillover fitting to an outer surface of a bottom wall of the raceway channel.

9. The spillover fitting of claim 8, wherein the attachment member comprises at least one rail that mates with at least one slot on the outer surface of the bottom wall of the raceway channel, the fitting secured to the raceway channel by at least one fastener that secures the at least one rail of the attachment member to the at least one slot of the raceway channel.

10. A spillover fitting for routing cable out of a cable raceway channel, the spillover fitting comprising:
a transition guide that receives cable from a raceway channel and directs the cable over a sidewall of the raceway channel, the transition guide defining a cable channel having a bottom wall and upright side walls, and further comprising a cable entry end, an angled central portion and a cable exit end, wherein the transition guide is oriented at an angle less than 90° to the raceway channel when mounted thereto;
a downward guide that receives cable from the transition guide and directs it downwardly with respect to the raceway channel; and
an attachment member for securing the spillover fitting to an outer surface of a bottom wall of the raceway channel.

11. The spillover fitting of claim 10, wherein the cable entry end and cable exit end have at least a 2″ minimum bend radius.

12. The spillover fitting of claim 10, wherein the attachment member comprises at least one rail that mates with at least one slot on the outer surface of the bottom wall of the raceway channel, the fitting secured to the raceway channel by at least one fastener that secures the at least one rail of the attachment member to the at least one slot of the raceway channel.

13. The spillover fitting of claim 10, further comprising a hinged cover located to cover the downward guide when the hinged cover is closed.

14. A cable raceway system comprising:
a raceway channel that conducts cable in a horizontal direction, the raceway channel having at least one sidewall and a bottom wall;
a spillover fitting that mounts to the raceway channel and conducts cable upward and over the sidewall of the raceway channel, wherein the spillover fitting comprises a transition guide that receives cable from a raceway channel and directs the cable over the sidewall of the raceway channel, the transition guide oriented at an angle less than 90° to the raceway channel; and
a downward guide that receives cable from the transition guide and directs it downwardly with respect to the raceway channel.

15. The cable raceway system of claim 14, wherein the transition guide includes a cable entry end and a cable exit end, the cable entry end and the cable exit end having at least a 2″ minimum bend radius.

16. The cable raceway system of claim 14 wherein the spillover fitting further comprises an attachment member for securing the spillover fitting to an outer surface of a bottom wall of the raceway channel.

17. The cable raceway system of claim 16, wherein the attachment member comprises at least one rail that mates with at least one slot on the outer surface of the bottom wall of the raceway channel, the fitting secured to the raceway channel by at least one fastener that secures the at least one rail of the attachment member to the at least one slot of the raceway channel.

18. The cable raceway system of claim 14 further comprising a T-section located between the transition guide and the downward guide, the T-section adapted to allow cable to be routed into the downward section or to allow cable to bypass the downward section and continue in a horizontal direction along a subsidiary channel.

19. A cable raceway system comprising:
a raceway channel that conducts cable in a horizontal direction, the raceway channel having at least one side wall and a bottom wall;
a spillover fitting that mounts to the raceway channel and conducts cable upward and over the sidewall of the raceway channel, wherein the spillover fitting comprises a transition guide that receives cable from a raceway channel and directs the cable over a sidewall of the raceway channel, the transition guide oriented at an angle less than 90° to the raceway channel;
a downward guide that receives cable from the transition guide and directs it downwardly with respect to the raceway channel; and
an attachment member for securing the spillover fitting to an outer surface of a bottom wall of the raceway channel.

20. The cable raceway system of claim 19, wherein the transition guide includes a cable entry end and a cable exit end, the cable entry end and the cable exit end having at least a 2″ minimum bend radius.

21. The cable raceway system of claim 19, wherein the attachment member comprises at least one rail that mates with at least one slot on the outer surface of the bottom wall of the raceway channel, the fitting secured to the raceway channel by at least one fastener that secures the at least one rail of the attachment member to the at least one slot of the raceway channel.

22. The cable raceway system of claim 19 further comprising a T-section located between the transition guide and the downward guide, the T-section adapted to allow cable to be routed into the downward section or to allow cable to bypass the downward section and continue in a horizontal direction along a subsidiary channel.
